(19) United States
(12) Patent Application Publication
(10) Pub. No.: US 2004/0213023 A1
(43) Pub. Date: Oct. 28, 2004

(54) Off-line non-step adjustment voltage regulator

(76) Inventor: Lien-Ching Chen, Shulin City (TW)

Correspondence Address: TROXELL LAW OFFICE PLLC, SUITE 1404, 5205 LEESBURG PIKE, FALLS CHURCH, VA, 22041, US

(21) Appl. No.: 10/419,749

(22) Filed: Apr. 22, 2003

(51) Int. Cl. H02H 7/10

(52) U.S. Cl. 363/50

(57) ABSTRACT

An off-line non-step adjustment voltage regulator. The inventive voltage regulator employs a high frequency switch mode to perform the electricity transformation in a converter, and employs an appropriate micro-processing control to couple the energy of the converter to an output end via a transformer so as to form a serial increasing/decreasing effect. Then, an output voltage is output, and is sent to a control circuit. The output voltage will be compared with a reference value so as to control the stability of the output voltage. Therefore, the invention can achieve the objective of performing efficiently, saving energy and precise non-section adjustment voltage regulation so as to reduce the system cost. Furthermore, the inventive voltage regulator is suitable to each stage of the voltage regulation equipments with different capacities.

### BACKGROUND OF THE INVENTION

1. Field of the Invention

The present invention relates an off-line non-step adjustment voltage regulator, and particularly to an off-line non-step adjustment voltage regulator applied in a power system.

2. Description of the Prior Art

Because of the well development of the semiconductor and the single-chip controller (central processing unit), a voltage regulator is commonly used in an electrical system, particularly in an uninterruptible power supply. However, in the prior art voltage regulator, it is usually composed of conventional electrical elements, such as a motor servo, SCR phase controller, end point voltage variation circuit, magnetic saturation circuit and so on. Therefore, the prior art voltage regulator is cumbersome, inefficient, and costly. This makes it unsuitable in the present market.

Please refer to FIG. 1. FIG. 1 is a perspective diagram of a current transforming circuit 1 of a half-bridge voltage regulator. In the high frequency switching power supply, the current transforming circuit 1 is applied in a system having smaller capacity. The power element of the circuit can be a silicon control rectifier (SCR), a metal-oxide-semiconductor field-effect transistor (MOSFET), an insulated gate bipolar transistor (IGBT), or a transistor. Based on different capacities, different specifications are used. In the present industry circle, the most preferred power element is the IGBT, and the MOSFET is also preferred.

By combining the well-developed single-chip controller and a pulse-width modulating (PWM) circuit, the high frequency AC/AC converter can be produced, and it will be simultaneously latched with an input power source. The sine wave power source will use the transformer to couple the energy to the main output power source so as to generate a stable output voltage. Because the voltage regulator is standardized and defined in an input range of ±15% variation, the present transformer tests the energy twice and supply the energy by ±15%, and tests the energy once so as to add the zero-crossing triggering switch, and operates according to the output. Therefore, the AC/AC converter only requires 15% of power and can achieve the stability of ±1% output.

The present invention provides an off-line non-step adjustment voltage regulator so as to reduce the cost and improve the efficiency. Compared with the prior art voltage regulator, the efficiency of the voltage regulator according to the invention is increased by 7˜10% so as to greatly reduce the cost. Furthermore, compared to the prior art motor servo voltage regulator, the inventive voltage regulator can react more quickly.

### SUMMARY OF THE INVENTION

The present invention relates an off-line non-step adjustment voltage regulator. The inventive voltage regulator employs a high frequency switch mode to perform the electricity transformation in an AC/AC rectifier, and employs an appropriate micro-processing control to couple the energy of the AC/AC rectifier to an output end via a transformer so as to form a serial increasing/decreasing effect. Then, an output voltage is output, and is sent to a control circuit. The output voltage will be compared with a reference value so as to control the stability of the output voltage. Therefore, the invention can achieve the objective of performing efficiently, saving energy and precise non-section adjustment voltage regulation.

In order to achieve the above objective, the off-line non-step adjustment voltage regulator according to the present invention comprises: a transformer; a first electromagnetic interference (EMI) shielding circuit connected to the transformer; an alternating filter connected to the input end of the first electromagnetic interference shielding circuit; a rectifying circuit connected to the input end of the alternating filter; a rectifier connected to the input end of the rectifying circuit; a surge suppress circuit connected to the input end of the rectifier; and a second electromagnetic interference shielding circuit connected to the input end of the surge suppress circuit.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a half-bridge current transforming circuit in a prior art voltage regulator;

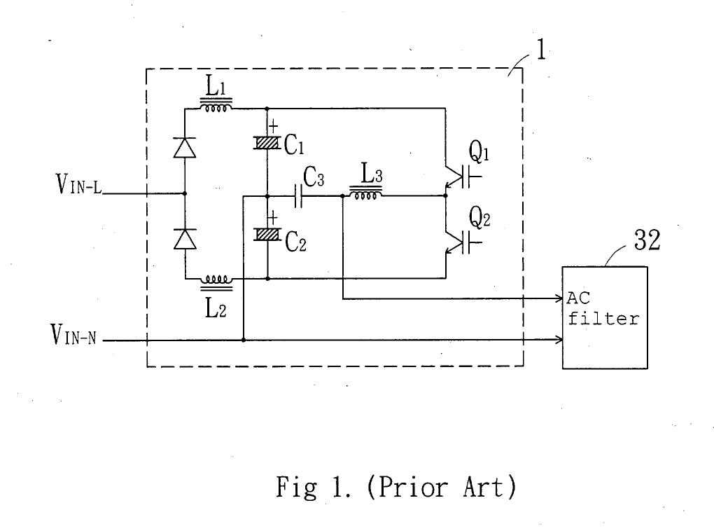

FIG. 2 is a circuit block diagram of an off-line non-step adjustment voltage regulator according to the invention;

FIG. 3 is a perspective diagram of a half-bridge current transforming circuit used in FIG. 2;

FIG. 4 is perspective diagram of a full-bridge current transforming circuit used in FIG. 2;

FIG. 5A is a perspective diagram of a circuit of a preferred embodiment according to the invention;

FIG. 5B is a voltage list of the circuit in FIG. 5A; and

FIG. 6 is a circuit perspective diagram of a control circuit of a preferred embodiment according to the invention.

### DETAILED DESCRIPTION OF THE PREFERRED EMBODIMENT

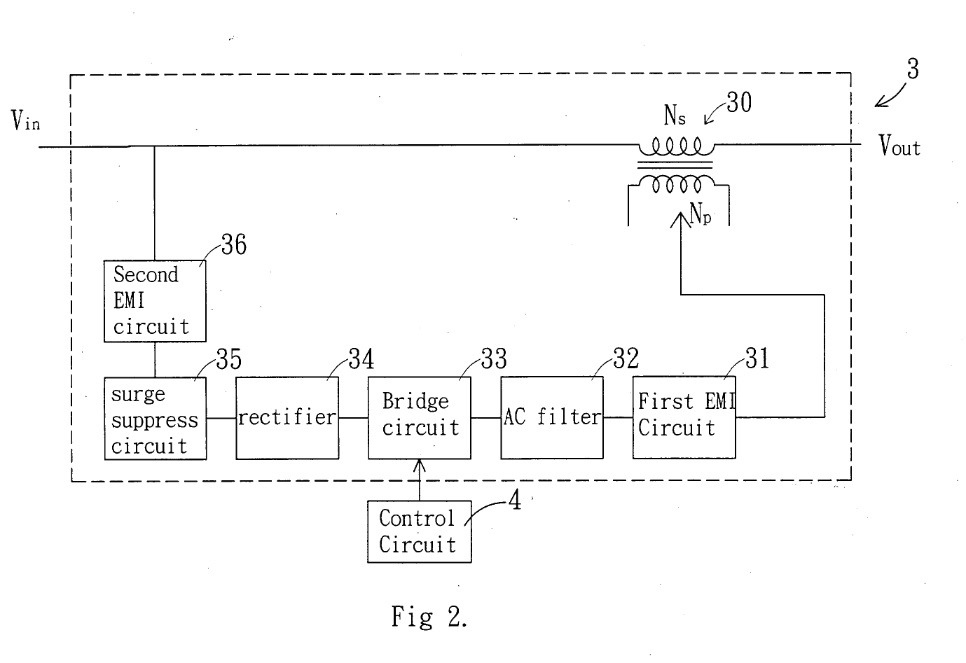

FIG. 2 is a circuit block diagram of an off-line non-step adjustment voltage regulator 3 according to the invention. The voltage regulator 3 comprises a transformer 30, a first electromagnetic interference (EMI) shielding circuit 31 connected to the transformer 30; an alternating filter 32 connected to the input end of the first electromagnetic interference shielding circuit 31; a half-bridge or full-bridge circuit 33 connected to the input end of the alternating filter 32; a rectifier 34 connected to the input end of the half-bridge or full-bridge circuit 33; a surge suppress circuit 35 connected to the input end of the rectifier 34; and a second electromagnetic interference shielding circuit 36 connected to the input end of the surge suppress circuit 35.

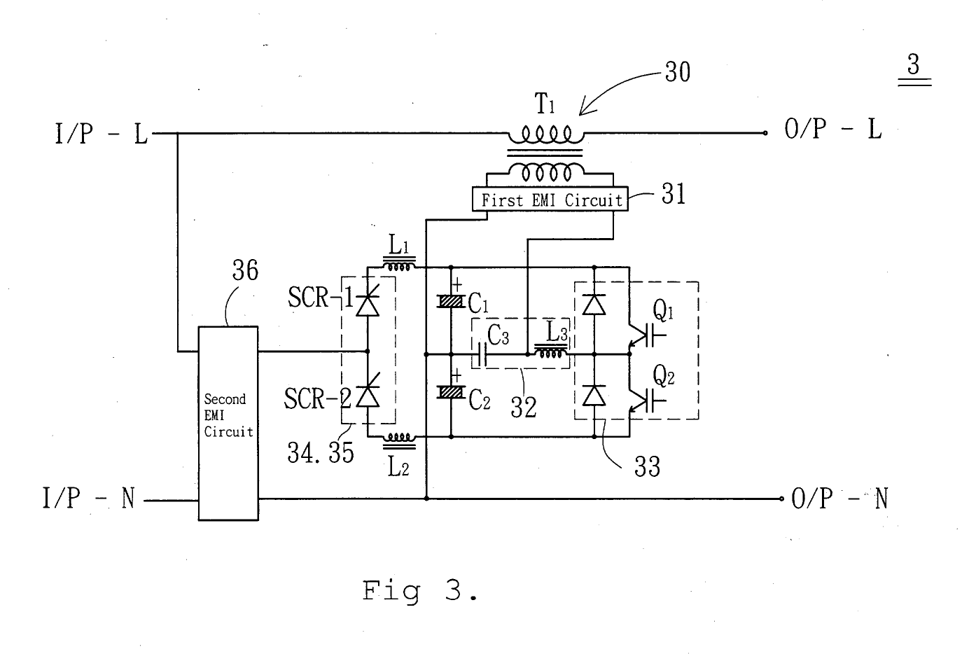

FIG. 3 is a perspective diagram of a half-bridge current transforming circuit used in FIG. 2. The alternating filter 32 is composed of the inductance capacitance element L₃. C₃; the half-bridge converter circuit 33 is composed of two power elements Q₁, Q₂ and two diodes; the rectifier 34 and the surge suppress circuit 35 are composed of two silicon control diodes SCR-1, SCR-2. When the input voltage is inputted in the first silicon control diode SCR-1 and second silicon control diode SCR-2, 180°˜0°, 360°˜181° silicon control rectifying diode slow initiation triggering signals are outputted, and the first silicon control diode SCR-1 is initiated by 180°˜0° and the second silicon control diode SCR-2 is initiated by 360°˜181°. Because the relating current of the alternating wave input is slowly initiated from zero, after several weeks passing, the direct current bus voltage will be increased from 0V to the maximum, and then a valid suppress wave current is input. When the first silicon control diode 330 and the second silicon control diode 331 are operated according to the above signals, the direct current bus of the capacitor C1 and C2 will generate voltages of +248V_{DC}˜+373 V_{DC} and −248 V_{DC}˜−373 V_{DC} (according the range of 220 V_{AC}+−20%), and the power transistor element Q1 and Q2 will employ the pulse-width modulating control mode so as to be latched simultaneously with the input. The power transistor will be switched to 20 KHZ or higher frequency, and it will be changed to be sine wave by the AC output filter 32 and then be output.

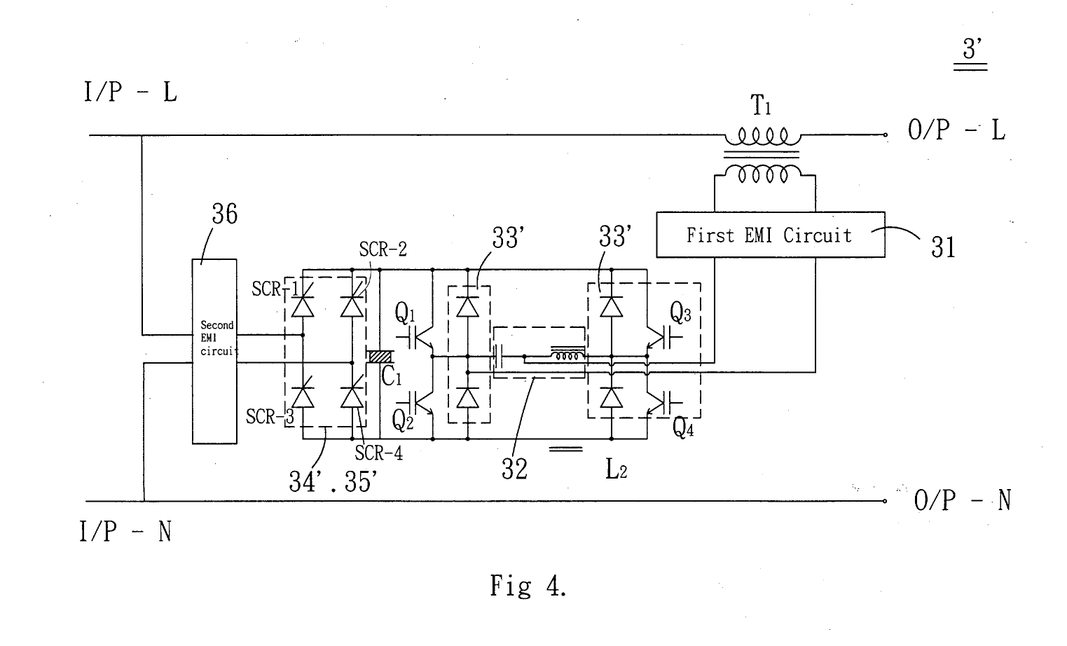

FIG. 4 is perspective diagram of a full-bridge current transforming circuit used in FIG. 2. The alternating filter 32 is composed of the inductance capacitance element L₃. C₃; the full-bridge current transforming circuit 33 is composed of four power transistor and four diodes; the rectifier 34′ and the surge suppress circuit 35′ are composed of four silicon control diodes SCR-1, SCR-2, SCR-3 and SCR-4; the operation principle of the other portion of the circuit is the same as that in FIG. 3, and it will not described in detail.

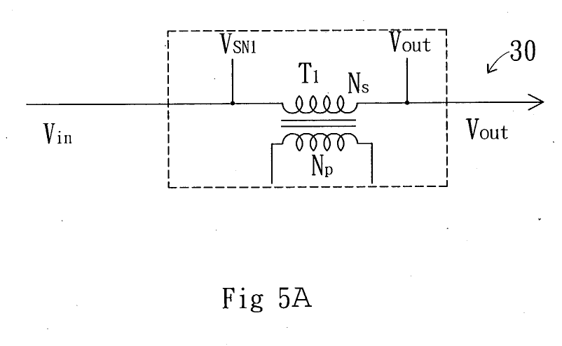

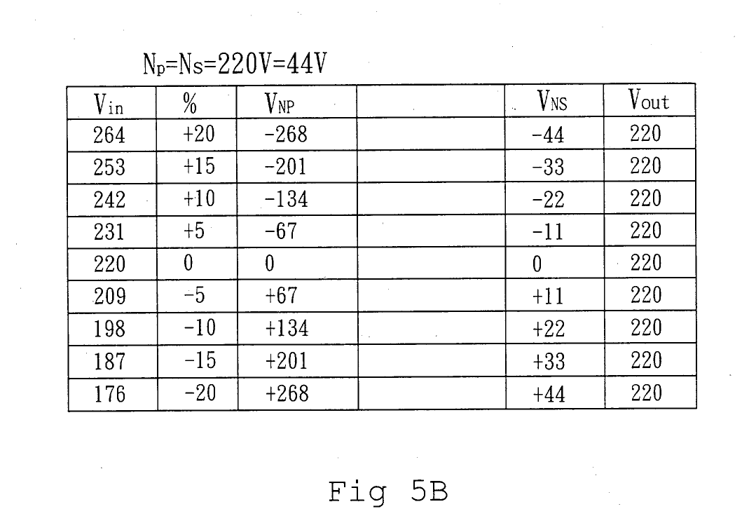

As shown in FIGS. 5A and 5B, the notation “+” represents a positive polarity, and “−” represents a negative polarity. By detecting and comparing the voltages V_{IN} and V_{out(REF)} (the output setting reference value) at two ends, when V_{IN>}V_{out(REF)}, it is negative polarity and when V_{IN<}V_{out(REF)}, it is positive polarity.

As described above, in FIG. 5A, when the input voltage V_{IN} forms a serial loop by passing through the N_{S} coil, and the once testing of the transformer T₁ is supplied with a power source by the AC/AC rectifier, as shown in the table, when the input voltage is higher than the standard rated voltage value (namely, when standard rated voltage value is 220V and equal to V_{out(REF)}), a resistance voltage will be generated at the N_{S} end so as to decrease the input voltage, the value of the resistance voltage is controlled by the AC/AC converter by means of precise feedback and energy transformation. This makes the output voltage capable of detecting the rated voltage regulation value. In the contrary, when the input voltage is lower than the rated voltage value, then an inverse voltage will generated at the Np end so that the voltage at the Np end and the input voltage will be serially connected and cause the effect of positive polarity. The AC/AC converter will control the same voltage value, and output the same rated value.

As shown in the above table, this is a serial circuit, and when the input voltage is at the maximum or minimum, the AC/AC converter will supply the maximum power. However, when the input is equal to the output voltage, the AC/AC converter will supply little electrical power. Therefore, the efficiency is the highest, almost beyond 95%.

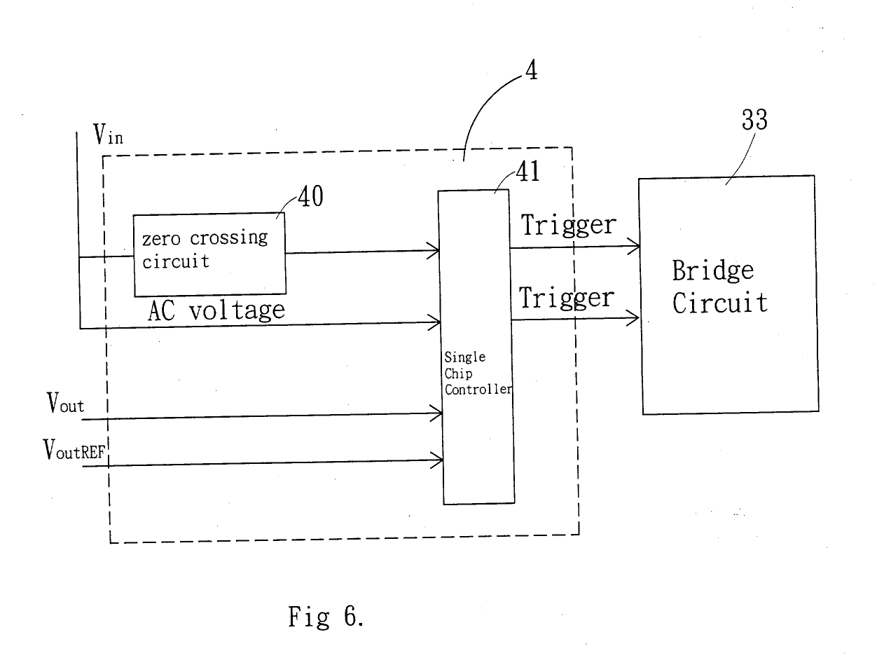

In order to achieve the above effect, it should be noticed that the voltage waveform of the rectifier must be always simultaneous with the voltage. As shown in FIG. 6, when the input voltage V_{IN} is passed through the zero-crossing circuit 40, the rising edge or drooping edge level voltage, the same as the local phone, will be generated and then sent to the single-chip controller 41 so that the output frequency, waveform and the input will be latched simultaneously. Therefore, the single-chip of the single-chip controller 41 will output a pulse-width modulating triggering signal having the same frequency and the same phase according to the waveform, and the signal drive circuit will drive the power elements of the inverter. When the input voltage is inputted normally, the zero-crossing circuit 40 will simultaneously make the single-chip controller 41 operative, and the single-chip will perform judgment and calculation based on the waveform and sent out 180°˜0°, 360°˜181° silicon control rectifying diode slow initiation triggering signals. As shown in FIG. 6, the first silicon control diode is initiated by the 180°˜0° signal, and the second silicon control diode is initiated by the 360°˜181° signal. Because the relating current of the alternating wave input is slowly initiated from zero, after several weeks passing, the direct current bus voltage will be increased from 0V to the maximum so that the valid suppress wave Current will be inputted.

The above is the detailed description of the off-line non-step adjustment voltage regulator according to the invention, and the followings are the advantages of the invention:

1. The cost is reduced and the circuit is simplified (only 15% of general capacity is required).

2. The structure is simple so as to extend the usage life of the power supply.

3. The efficiency is promoted and the power source is saved.

4. The characteristics of the circuit are good; the distortion of waveform is small; the harmonic wave is low; the static voltage regulation rate is better (±2%); the dynamic voltage dropping is reduced and the voltage regulator can be accurately adjusted in a non-section manner, and there is no mechanic components, all of the components are electrical; the reacting time of the voltage regulator is short and the voltage regulator is returned to be stable in 20 ms.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An non-step adjustment voltage regulator comprising:
a transformer;
a first electromagnetic interference (EMI) shielding circuit connected to the transformer;
an alternating filter connected to the input end of the first electromagnetic interference shielding circuit;
a rectifying circuit connected to the input end of the alternating filter;
a rectifier connected to the input end of the rectifying circuit;
a surge suppress circuit connected to the input end of the rectifier; and
a second electromagnetic interference shielding circuit connected to the input end of the surge suppress circuit.

2. The non-step adjustment voltage regulator of claim 1, wherein the rectifying circuit is a half-bridge circuit.

3. The non-step adjustment voltage regulator of claim 1, wherein the rectifying circuit is a full-bridge circuit.

4. The non-step adjustment voltage regulator of claim 1 further comprising a control circuit for receiving an output voltage and comparing it with a reference value so as to control the stability of the output voltage.

5. The non-step adjustment voltage regulator of claim 1 further comprising a control circuit.

6. The non-step adjustment voltage regulator of claim 5, wherein the control circuit comprises a single-chip controller for receiving the input voltage via a zero-crossing circuit so as to generate a rising edge or dropping edge level voltage the same as the local phone, and input a single-chip controller so as to latch the output frequency, waveform and the input, the single-chip controller will output a pulse-width modulating triggering signal according to the waveform so as to drive the power elements of the inverter, the zero-crossing circuit will enable the operation of the single-chip controller so as to initiate the triggering signal.
